(19) United States
(12) Patent Application Publication
(10) Pub. No.: US 2019/0242765 A1
(43) Pub. Date: Aug. 8, 2019

(54) Torque Measuring Device

(71) Applicant: CPT ZWEI GMBH, HANNOVER (DE)

(72) Inventor: CORNEL MARIAN AMARIEI, FLORESTI (RO)

(21) Appl. No.: 16/341,935

(22) PCT Filed: Oct. 5, 2017
(86) PCT No.: PCT/EP2017/075397

§ 371 Date: Apr. 15, 2019

(30) Foreign Application Priority Data
Oct. 13, 2016 (DE) 10 2016 219 962.5

(51) Int. Cl. G01L 3/10; G01L 3/12

(52) U.S. Cl. CPC G01L 3/108; G01L 3/12

(57) ABSTRACT

A torque measuring device for measuring the torque in a shaft that is subjected to torsion and has two axially arranged shaft sections. A first shaft section functions as a driveshaft and a second shaft section functions as an output shaft and is connected to a load-dependent sensor. An annular light-sensitive element is attached to the first shaft section an annular light-emitting element is arranged on the second shaft section. A measuring body with a load-dependent sensor is disposed between the shaft sections. The annular light-sensitive element is electrically conductively connected to the annular light-emitting element via the load-dependent sensor. A lamp element and a photoelectric element are arranged outside the shaft. Light from the lamp element is directed towards the annular light-sensitive element, and the light emitted by the light-emitting element is received by the photoelectric element and supplied to an evaluation unit.

The invention relates to a torque measurement device for measuring the torque in a shaft, loaded by torsion, having two axially arranged shaft sections, wherein a first shaft section serves as driveshaft and a second shaft section serves as output shaft and is connected to a load-dependent sensor.

It is often necessary, both for applications in industry and for applications in other fields, to determine the load on shafts due to torsional loads. Such torque measurement devices are required in particular in general automotive and vehicle applications.

Many arrangements for measuring torque on shafts are known from the known prior art.

In this case, electrical measurement resistors, usually in the form of strain gauges, are installed on the outer cylinder of a shaft. The measurement resistors may be arranged in the longitudinal direction or in a manner inclined with respect thereto.

US 2013/0024137 A1 describes a torque sensor in which a measurement element is arranged on a shaft for a bottom bracket of a bicycle, wherein the measurement element is arranged perpendicular to the radius of the shaft.

WO 2014/124617 A1 furthermore discloses a torque measurement device suitable for a bottom bracket, which torque measurement device comprises an inner shaft, provided as driveshaft, a hollow shaft, connected to the inner shaft, surrounding same and provided as output shaft, wherein the hollow shaft has a direct coating, comprising a strain gauge, for torque measurement purposes.

The invention is based on the object of providing a torque measurement device of the type mentioned at the outset, by way of which the torque load on a shaft is able to be acquired wirelessly.

According to the invention, the object is achieved by a torque measurement device that has the features specified in claim 1.

Advantageous refinements are the subject matter of the dependent claims.

In the torque measurement device, an annular light-sensitive element is arranged on the first shaft section and an annular light-emitting element is arranged on the second shaft section. A measurement body having a load-dependent sensor is situated between the shaft sections.

The annular light-sensitive element is electrically conductively connected to the annular light-emitting element by way of the load-dependent resistor. A luminous element and a photoelement are arranged so as to be stationary outside the shaft such that the light from the luminous element is directed onto the annular light-sensitive element and the light emitted by the light-emitting element is received by the photoelement and fed to an evaluation unit.

The arrangement makes it possible to determine an electrical resistance value on a rotating shaft, this being a measure of the torque transmitted by the shaft, and to transmit this value wirelessly to a receiver arranged so as to be stationary outside the moving shaft.

One advantageous configuration makes provision for the load-dependent sensor to be an electrical resistance sensor. Such sensors are inexpensive and allow an accurate measurement.

A light-emitting diode (called LED for short) expediently serves as luminous element.

In a further advantageous configuration, the load-dependent resistor is arranged on a measurement body that is arranged in a rotationally secure manner between the first shaft section and the second shaft section.

It is furthermore advantageous to arrange the load-dependent resistor in the longitudinal direction on the outside of the measurement body. This results in high measurement accuracy and good accessibility to the measurement resistor.

A further advantageous configuration makes provision for a plurality of electrical resistance sensors to be arranged on the measurement body. A higher sensitivity of the measurement arrangement is thereby able to be achieved.

The electrical resistance sensors may be arranged in a series circuit or a parallel circuit.

One particularly advantageous configuration makes provision for the electrical resistance sensors to use a Wheatstone bridge circuit. This makes it possible to achieve a good evaluation of the measurement result.

The invention is explained in more detail below with reference to an exemplary embodiment.

In the associated drawings:

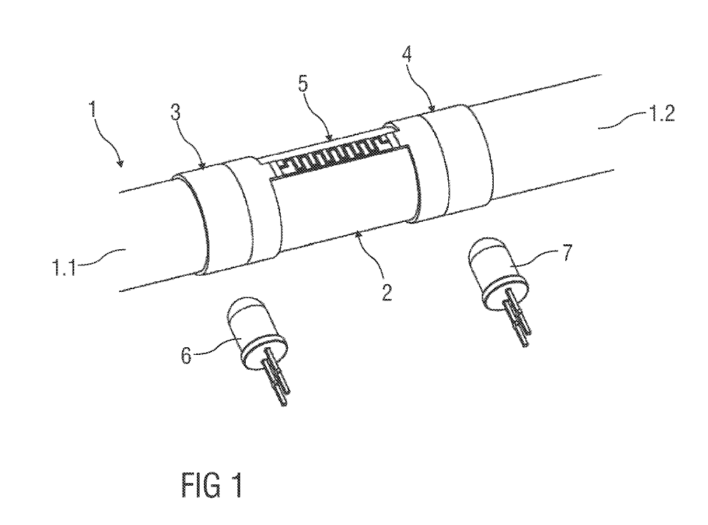

FIG. 1 shows a perspective illustration of the measurement device,

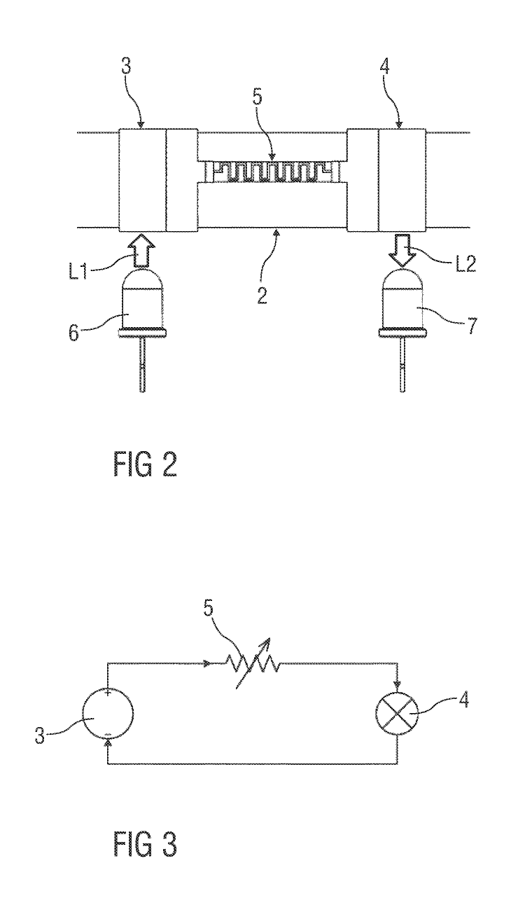

FIG. 2 shows a schematic illustration of the operation of the measurement device and

FIG. 3 shows an equivalent circuit diagram of the electrical components.

In all of the figures, the same reference signs are used for mutually corresponding parts.

As is visible in FIG. 1, the shaft 1 consists of a first shaft section 1.1 and a second shaft section 1.2.

In the case that is illustrated, the first shaft section 1.1 serves as driveshaft into which a torque to be transmitted is introduced, and the second shaft section 1.2 serves as output shaft to which the torque is transmitted. A light-sensitive element 3 is situated on the first shaft section 1.1. A light-emitting element 4 is arranged on the second shaft section 1.2. The light-sensitive element 3 and the light-emitting element 4 are each arranged on the circumference of the shaft sections 1.1 and 1.2.

Between the first shaft section 1.1 and the second shaft section 1.2, there is situated a further shaft section, serving as measurement body 2. The load-dependent sensor 5, which is designed as an electrical measurement resistor, is arranged in the longitudinal direction on the outer cylinder of the measurement body 2.

A luminous element 6 and a photoelement 7 are arranged so as to be stationary outside the shaft 1.

FIG. 2 explains the operation of the measurement device. A first light beam L1, emitted by the luminous element 6 arranged so as to be stationary outside the shaft 1, impinges on the light-sensitive element 3 arranged on the first shaft section 1.1, which light-sensitive element generates an electric current that is routed to the light-emitting element 4 via the load-dependent sensor 5.

The load-dependent sensor 5, which is designed as a measurement resistor, is arranged in the measurement body 2 such that, in the event of torsion of the measurement body 2 due to the torque, to be determined, that is transmitted to the measurement body 2, its resistance value changes.

Depending on the respective resistance value of the measurement resistor, and therefore also depending on the torque acting on the shaft 1, an electric current, whose value is a measure of the torque to be measured, impinges on the light-emitting element 4.

Depending on the current strength, the light-emitting element 4 illuminates with an intensity that is dependent on the torque to be determined. The second light beam L2 emanating from the light-emitting element 4 impinges on the photoelement 7, arranged so as to be stationary outside the shaft 1, which photoelement delivers a current value that is a measure of the torque to be determined.

FIG. 3 illustrates the equivalent circuit diagram of the electrical components used in the measurement body 2. The current generated by the light-sensitive element 3 flows through the load-dependent sensor 5, which depends on the torsion arising in the measurement body 2 and brought about by the torque that is transmitted. The light-emitting element 4 illuminates with differing intensity depending on the strength of this current.

### LIST OF REFERENCE SIGNS

1 shaft
1.1 first shaft section
1.2 second shaft section

2 measurement body

3 light-sensitive element

4 light-emitting element

5 load-dependent sensor

6 luminous element

7 photoelement

L1 first light beam

L2 second light beam

1-8. (canceled)

9. A torque measurement device for measuring a torque in a shaft that is loaded by torsion, the shaft having two axially arranged shaft sections, including a first shaft section being a driveshaft and a second shaft section being an output shaft, the torque measurement device comprising:
an annular light-sensitive element stalled on the first shaft section;
a measurement body with a load-dependent sensor disposed between said two shaft sections;
an annular light-emitting element disposed on said second shaft section;
said load-dependent sensor electrically conductively connecting said annular light-sensitive element to said annular light-emitting element; and
a luminous element and a photoelement arranged outside said shaft, said luminous element being disposed to emit light onto said annular light-sensitive element, and said photoelement being disposed to receive light emitted by said light-emitting element and configured to feed a corresponding signal to an evaluation unit.

10. The torque measurement device according to claim 9, wherein said load-dependent sensor is an electrical resistance sensor.

11. The torque measurement device according to claim 9, wherein said luminous element is a light-emitting diode.

12. The torque measurement device according to claim 9, wherein said load-dependent sensor is arranged on said measurement body and said measurement body is arranged between the first shaft section and the second shaft section.

13. The torque measurement device according to claim 11, wherein said load-dependent sensor is disposed on an outside of said measurement body and extending in a longitudinal direction.

14. The torque measurement device according to claim 9, wherein a plurality of electrical resistance sensors are arranged on said measurement body.

15. The torque measurement device according to claim 14, wherein said electrical resistance sensors are connected in a series circuit.

16. The torque measurement device according to claim 14, wherein said electrical resistance sensors are connected in a parallel circuit.

17. The torque measurement device according to claim 14, wherein said electrical resistance sensors are connected in a Wheatstone bridge circuit.
